(19) United States
(12) Patent Application Publication
(10) Pub. No.: US 2026/0283874 A1
(43) Pub. Date: Sep. 24, 2026

(54) INDIVIDUAL-CONVEYING DOLLY

(71) Applicant: David Faison, Lincoln, DE (US)

(72) Inventor: David Faison, Lincoln, DE (US)

(21) Appl. No.: 19/083,747

(22) Filed: Mar. 19, 2025

(51) Int. Cl. A61G 5/14; A61G 5/10; A61G 5/12

(52) U.S. Cl. CPC A61G 5/14; A61G 5/1059; A61G 5/122; A61G 5/125

(57) ABSTRACT

Client's Docket No. SK17129 A dolly apparatus for transporting individuals includes a frame with a platform.

A pair of wheels is rotatably mounted to the frame. The wheels are rotatable around a shared axis and are positioned on opposite lateral sides of the platform. A chair is mounted on the frame and is positioned over the platform. A tilt mechanism is mounted to the frame and is configured to tilt the frame alternately forward and backward. A lift mechanism is mounted to the frame and is operable to move the chair between a lowered position and a raised position.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### g) BACKGROUND OF THE INVENTION

### (1) Field of the Invention

The disclosure relates to dollies and more particularly pertains to a new dolly for transporting individuals.

### (2) Description of Related Art Including Information Disclosed Under 37 CFR 1.97 and 1.98

Individuals often have impediments to their mobility due to age, illness, injury, or the like. It can be difficult to transport such individuals, even across short distances. While wheelchairs are readily available and improve the mobility of such individuals, getting in and out of wheelchairs is still a challenging process for some. Dollies are available to address this issue, but such apparatuses often resort to straps which are uncomfortable for individuals and unnecessary for those who only need assistance reaching a seated position. Existing dollies may also position individuals in uncomfortable positions.

The prior art fails, however, to describe such a dolly which facilitates individuals in sitting and getting up from a chair. Such a dolly could use a tilting mechanism to tilt a frame on which a chair is situated and a lift mechanism to alternately raise and lower the chair on the frame. Such a new apparatus would be beneficial in providing individuals with a comfortable way to move and an easier way to get on and off of the apparatus than options currently known to the art.

### (h) BRIEF SUMMARY OF THE INVENTION

An embodiment of the disclosure meets the needs presented above by generally comprising a frame with a platform. A pair of wheels is rotatably mounted to the frame. The wheels are rotatable around a shared axis and are positioned on opposite lateral sides of the platform. A chair is mounted on the frame and is positioned over the platform. A tilt mechanism is mounted to the frame and is configured to tilt the frame alternately forward and backward.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (I) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an in-use view of a dolly apparatus according to an embodiment of the disclosure.

FIG. 2 is a perspective view of an embodiment of the disclosure.

FIG. 3 is a bottom view of an embodiment of the disclosure.

FIG. 4 is a front view of an embodiment of the disclosure.

FIG. 5 is a back view of an embodiment of the disclosure.

### (J) DETAILED DESCRIPTION OF THE INVENTION

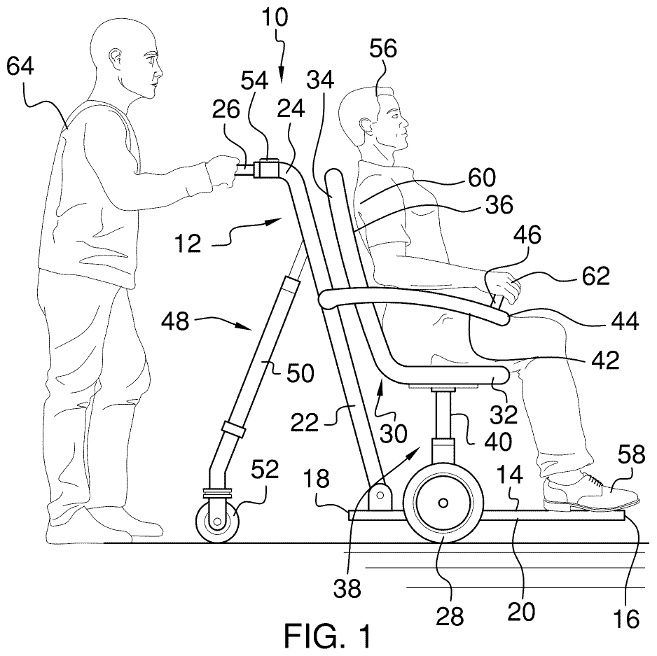

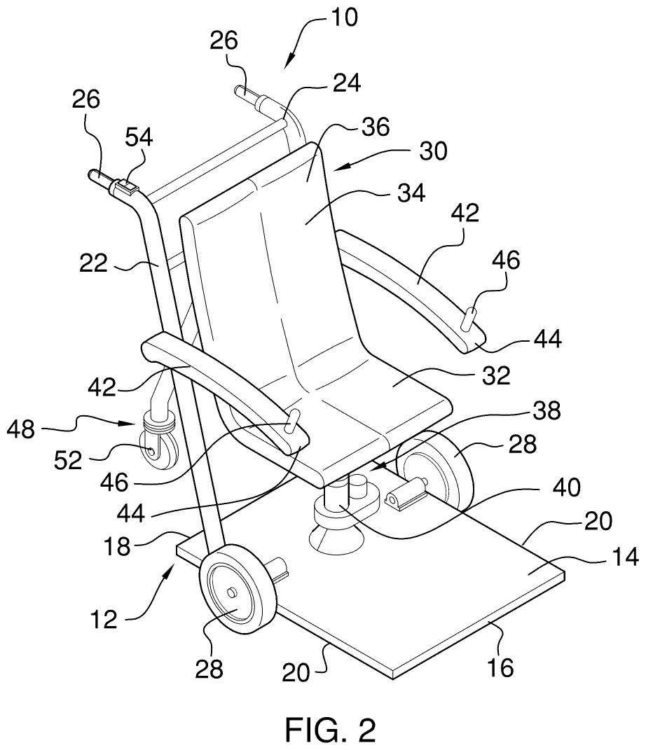

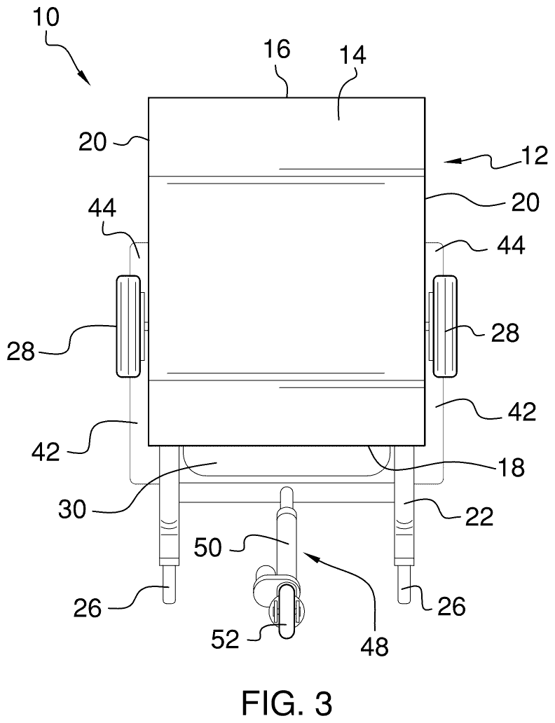

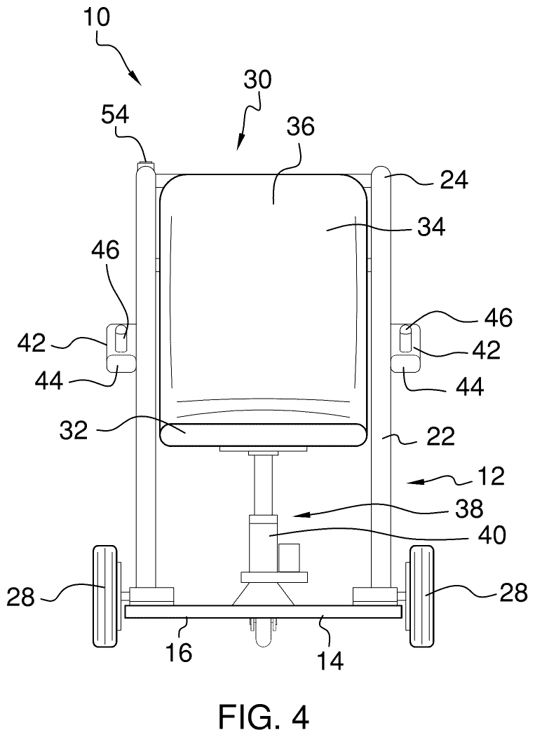

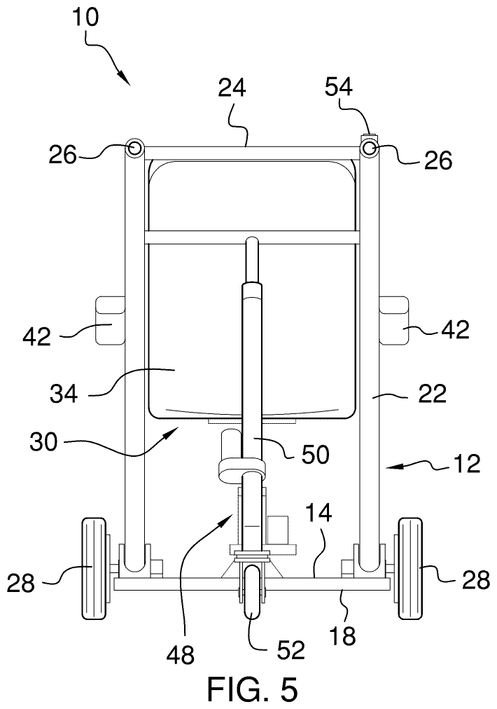

With reference now to the drawings, and in particular to FIGS. 1 through 5 thereof, a new dolly embodying the principles and concepts of an embodiment of the disclosure and generally designated by the reference numeral 10 will be described.

As best illustrated in FIGS. 1 through 5, the dolly apparatus 10 generally comprises a frame 12 with a platform 14, a back member 22, and a pair of handles 26. The back member 22 is coupled to the back member 22 near a back end 18 of the platform 14 and extends upwardly from the platform 14. The handles 26 are coupled to a top end 24 of the back member 22 and extend rearwardly from the back member 22 with respect to the platform 14. A pair of wheels 28 is rotatably mounted to the frame 12. The wheels 28 are rotatable around a shared axis and are positioned on opposite lateral sides 20 of the platform 14.

A chair 30 is mounted to the frame 12 over the platform 14 to support an individual 56 in a seated position on the frame 12. The chair 30 has a seat 32 and a backrest 34. The backrest 34 is coupled to and extends upwardly from the seat 32. A resting surface 36 of the backrest 34 for supporting the individual's 56 back 60 faces forwardly with respect to the platform 14. The chair 30 is movable between a lowered position and a raised position with respect to the platform 14 to facilitate positioning the individual 56 on the chair 30 and aiding the individual 56 in leaving the chair 30. A lift mechanism 38 is coupled to the chair 30 and the frame 12. The lift mechanism 38 is configured to selectively move the chair 30 between the lowered position and the raised position. The lift mechanism 38 comprises a lift linear actuator 40, which may include an electric linear actuator, a hydraulic cylinder, a pneumatic cylinder, or the like.

A pair of armrests 42 is mounted to the frame 12. The armrests 42 are positioned on and extend forwardly from the back member 22. The pair of armrests 42 is positioned opposite each other across the chair 30. Each armrest 42 has a grip 46 mounted thereon adjacent to a forward end 44 of the armrest 42. The grip 46 for each armrest 42 extends upwardly from the associated armrest 42 and is sized and configured to be grasped by the individual's 56 hands 62 when the individual 56 sits in the chair 30.

A tilt mechanism 48 is mounted to the frame 12 and is configured to selectively tilt the frame 12 alternately forward and backward. Tilting the frame 12 forward facilitates moving the individual 56 alternately on and off the chair 30. The tilt mechanism 48 includes a tilt linear actuator 50 which is positioned to engage a ground surface upon which the pair of wheels 28 is supported to tilt the frame 12. The tilt linear actuator 50 may include an electric linear actuator, a hydraulic cylinder, a pneumatic cylinder, or the like. The tilt mechanism 48 also includes a caster 52 which is coupled to the tilt linear actuator 50 distal from the frame 12. The caster 52 rests on the ground surface during use so that the tilt linear actuator 50 may urge the frame 12 to rotate via the caster 52. A controller 54 is operatively coupled to the lift mechanism 38 and the tilt mechanism 48. The controller 54 is mounted to the frame 12 adjacent to one of the handles 26 but may be remote from the frame 12 in other embodiments.

In use, an aide 64 grasps the handles 26 of the frame 12 and moves the dolly apparatus 10 around on the ground surface via the wheels 28. The frame 12 may pivot on the shared axis of the wheels 28 to tilt, thereby helping the individual 56 to get on and off the chair 30. The platform 14 may support the individual 56 as the individual 56 gets on or off the chair 30. While the individual 56 is seated on the chair 30, the platform 14 serves as a footrest to support the individual's 56 feet 58. To facilitate the individual 56 in sitting on the chair 30, the tilt mechanism 48 is actuated by the controller 54 to tilt the frame 12 in a first rotational direction around the shared axis of the wheels 28 to lower a front end 16 of the platform 14 downwardly toward the ground surface.

The chair 30 may be positioned as desired between the lowered position and the raised position using the lift mechanism 38 to help the individual 56 sit on the chair 30. For example, it may be desirable to position the chair 30 near or at the raised position to decrease a distance the individual 56 is required to move to sit on the chair 30 compared to when the chair 30 is in the lowered position. Such use may help individuals with limited mobility and strength to sit and rise from the chair 30. Then, the chair 30 may be moved toward the lowered position after the individual 56 is seated to rest the individual's 56 feet 58 on the platform 14.

When the individual 56 is seated in the chair 30, the tilt mechanism 48 may be positioned so that the frame 12 is allowed to tilt in a second rotational direction opposite the first rotational direction. The tilt mechanism 48 may assist in supporting the frame 12 on the ground surface, including during a movement of the dolly apparatus 10 across the ground surface. The individual 56 may grasp the grips 46 to further assist in seating and unseating the individual 56 on and from the chair 30 respectively.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A dolly apparatus for transporting an individual, the dolly apparatus comprising:
a frame comprising a platform;
a pair of wheels rotatably mounted to the frame, the pair of wheels being rotatable around a shared axis, the pair of wheels being positioned on opposite lateral sides of the platform;
a chair mounted on the frame and positioned over the platform; and
a tilt mechanism mounted to the frame, the tilt mechanism being configured to tilt the frame alternately forward and backward.

2. The apparatus of claim 1, wherein the frame further comprises:
a back member coupled to and extending upwardly from the platform, the back member being positioned near a back end of the platform; and
a pair of handles coupled to a top end of the back member, the pair of handles extending rearwardly from the back member with respect to the platform.

3. The apparatus of claim 2, a pair of armrests mounted to the frame, the pair of armrests being positioned on and extending forwardly from the back member, the pair of armrests being positioned opposite each other across the chair.

4. The apparatus of claim 1, wherein the chair has a seat and a backrest, the backrest being coupled to and extending upwardly from the seat, a resting surface of the backrest facing forwardly with respect to the platform.

5. The apparatus of claim 1, wherein the chair is movable between a lowered position and a raised position with respect to the platform.

6. The apparatus of claim 5, further comprising a lift mechanism coupled to the chair and the frame, the lift mechanism being configured to move the chair between the lowered position and the raised position.

7. The apparatus of claim 6, wherein the lift mechanism comprises a lift linear actuator.

8. The apparatus of claim 1, wherein the tilt mechanism comprises a caster and a tilt linear actuator, the tilt linear actuator being coupled to and extending between the caster and the back member of the frame.

9. The apparatus of claim 6, further comprising a controller operatively coupled to the lift mechanism and the tilt mechanism.

10. The apparatus of claim 1, further comprising a controller operatively coupled to the tilt mechanism.

11. The apparatus of claim 1, further comprising a pair of armrests mounted to the frame, the pair of armrests being positioned opposite each other across the chair.

12. The apparatus of claim 11, further comprising a pair of grips, each grip of the pair of grips being mounted on an associated armrest of the pair of armrests, each grip being positioned adjacent to a forward end of the associated armrest and extending upwardly from the associated armrest.

13. A dolly apparatus for transporting an individual, the dolly apparatus comprising:
a frame comprising:
a platform;
a back member coupled to and extending upwardly from the platform, the back member being positioned near a back end of the platform; and
a pair of handles coupled to a top end of the back member, the pair of handles extending rearwardly from the back member with respect to the platform;
a pair of wheels rotatably mounted to the frame, the pair of wheels being rotatable around a shared axis, the pair of wheels being positioned on opposite lateral sides of the platform;
a chair mounted on the frame, the chair being positioned over the platform, the chair having a seat and a backrest, the backrest being coupled to and extending upwardly from the seat, a resting surface of the backrest facing forwardly with respect to the platform, the chair being movable between a lowered position and a raised position with respect to the platform;
a lift mechanism coupled to the chair and the frame, the lift mechanism being configured to move the chair between the lowered position and the raised position, the lift mechanism comprising a lift linear actuator;
a tilt mechanism mounted to the frame, the tilt mechanism being configured to tilt the frame alternately forward and backward, the tilt mechanism comprising a caster and a tilt linear actuator, the tilt linear actuator being coupled to and extending between the caster and the back member of the frame;
a controller operatively coupled to the lift mechanism and the tilt mechanism, the controller being mounted to the frame, the controller being positioned adjacent to one of the handles;
a pair of armrests mounted to the frame, the pair of armrests being positioned on and extending forwardly from the back member, the pair of armrests being positioned opposite each other across the chair; and
a pair of grips, each grip of the pair of grips being mounted on an associated armrest of the pair of armrests, each grip being positioned adjacent to a forward end of the associated armrest and extending upwardly from the associated armrest.
